(19) United States
(12) Patent Application Publication
(10) Pub. No.: US 2015/0295478 A1
(43) Pub. Date: Oct. 15, 2015

(54) MACHINE AND ACCESSORY

(71) Applicant: Remy Technologies, LLC, Pendleton, IN (US)

(72) Inventors: Alex Creviston, Muncie, IN (US); Chris Bledsoe, Anderson, IN (US)

(21) Appl. No.: 14/727,306

(22) Filed: Jun. 1, 2015

Related U.S. Application Data
(63) Continuation of application No. PCT/US2013/072829, filed on Dec. 3, 2013.
(60) Provisional application No. 61/733,552, filed on Dec. 5, 2012.

(51) Int. Cl. H02K 11/04; H02K 11/00

(52) U.S. Cl. CPC H02K 11/04; H02K 11/0094

(57) ABSTRACT

An electric machine having a stator and a rotor operably coupled therewith. An accessory is coupled with the electric machine and an electrical device is mounted in a housing. The housing may advantageously include a polymeric shell that is overmolded on a conductive element providing communication between the electrical device and an external circuit. In some embodiments, a printed circuit board is mounted within the housing and thermally coupled with a metallic base member. In other embodiments, a second printed circuit board is provided with the first printed circuit board having a substrate with a greater thermal conductivity than the substrate of the second printed circuit board. The first printed circuit board may include a MOSFET rectifier and may take the form of a ceramic printed circuit board with the second board being an FR-4 board. The electric machine may be advantageously employed as an alternator for a vehicle.

### CROSS-REFERENCE TO RELATED APPLICATION(S)

This application is a continuation of PCT International Patent Application No. PCT/US 13/72829 entitled ELECTRIC MACHINE AND ACCESSORY filed on Dec. 3, 2013, which claims priority to U.S. Provisional Patent Application Ser. No. 61/733,552 entitled ELECTRIC MACHINE AND ACCESSORY filed on Dec. 5, 2012. The entire disclosures of all the above-listed patent applications are incorporated herein by reference.

### BACKGROUND

1. Field of the Invention

The present invention relates to electric machines and, more particularly, electric machines having an accessory associated therewith.

2. Description of the Related Art

Electric machines include a stator and a rotor which rotates relative to the stator and may take the form of a motor, a generator or a motor/generator which is capable of selectively operating as both a motor and a generator. Such electric machines often have a rectifier or an inverter associated therewith to convert AC current to DC current or DC current to AC current.

One application of an electric machine that commonly employs a rectifier for converting AC current to DC current is an alternator for a vehicle. In a typical alternator, a belt operably couples the vehicle drive shaft to the alternator shaft and drivingly rotates the alternator rotor. The rotor rotates with DC current flowing in the field winding and produces an AC magnetic flux in the stationary stator. This time varying flux that links the rotor and stator serves to induce a voltage in the stator windings according to Faraday's law. Since the electrical power produced by operation of the alternator is AC, it is necessary to convert it to DC to be compatible with the electrical system of the vehicle, most notably the batteries.

A diode rectifier is typically used to convert the AC electrical power from the stator to DC electrical power. To accomplish this conversion, the rectifier typically employs 6 diodes, which behave like check valves that allow current to flow in only one direction. When the voltage on the anode side of the diode is larger than the voltage on the cathode side, the diode becomes forward biased and allows current to flow through it. When this condition does not exist, no current flows through the diode and it behaves like an open circuit. Using two diodes per stator phase, a conventional diode rectifier converts, or rectifies, the AC power into DC power with a corresponding voltage ripple.

It is also known in the art to employ active rectification, also referred to as synchronous rectification, in which metal--oxide--semiconductor field-effect transistors (“MOSFETs”) are used instead of diodes in each branch of a rectifier bridge. MOSFETs are used to eliminate the high voltage drop and power consumption experienced with conventional diode rectifiers.

The operation of electric machines generates heat and in some applications, a cooling system is necessary to remove excess heat. The stator windings are often responsible for generating a significant portion of the heat during operation of the electric machine and various methods of cooling electric machines have been developed. One common method of removing heat from an electric machine is the use of a fan to blow air across the stator windings and alternators typically include radial fans fixed to the alternator shaft on opposite ends of the rotor. These radial fans are often positioned near the stator windings and generate air flow across the end turns of the stator windings to remove heat therefrom.

### SUMMARY

The present invention provides an electric machine wherein an accessory associated with the electric machine is mounted proximate the electric machine and is disposed within a housing having an advantageous structure. The disclosed electric machine can be employed in many applications with its use as a vehicle alternator having rectifiers associated therewith being particularly advantageous.

One embodiment comprises an electric machine having a stator and a rotor operably coupled therewith. An accessory is operably coupled with the electric machine. The accessory includes a housing and an electrical device mounted within the housing. At least one conductive element extends through the housing and has an exposed portion disposed within the housing and an exterior portion extending outwardly form the housing. The exposed portion is conductively coupled with the electrical device and the exterior portion can be conductively coupled to an external circuit whereby the conductive element provides electrical communication between the electrical device and the external circuit.

Another embodiment comprises an electric machine having a stator and a rotor operably coupled therewith. An accessory is operably coupled with the electric machine and has a housing with a metallic base member and a polymeric shell member. The accessory also includes a first printed circuit board that is mounted within the housing and thermally coupled with the base member. At least one conductive element extends through the polymeric shell member and has an exposed portion disposed within the polymeric shell member and an exterior portion extending outwardly from the polymeric shell member. The exposed portion is conductively coupled with the first printed circuit board and the exterior portion can be conductively coupled with an external circuit whereby the conductive element provides electrical communication between the first printed circuit board and the external circuit.

Still another embodiment comprises an electric machine having a stator and a rotor operably coupled therewith. An accessory is operably coupled with the electric machine and has a housing with a metallic base member. The accessory also includes first and second printed circuit boards disposed within the housing with the first printed circuit board being thermally coupled with the base member and the second printed circuit board being spaced from the base member. The first printed circuit board has a first substrate and the second printed circuit board has a second substrate wherein the first substrate has a greater thermal conductivity than the second substrate.

In some of the embodiments, the accessory is in electrical communication with at least one stator coil of the electric machine. In such an embodiment, the accessory may advantageously include a printed circuit board having a MOSFET rectifier.

The housing may include a metallic base member that is thermally coupled with a printed circuit board. In such an embodiment, the metallic base member can provide electrical communication between the printed circuit board and an external circuit segment. For example, the base member can connect the printed circuit board to a ground.

In some of the embodiments, the accessory may include first and second printed circuit boards wherein the first printed circuit board is thermally coupled with the base member and the second printed circuit board includes control circuitry and is mounted on a polymeric shell member. In such embodiments, the first and second printed circuit boards may advantageously have different substrates wherein the substrate of the first printed circuit board has a greater thermal conductivity than the substrate of the second printed circuit board. For example, the first printed circuit board may be a ceramic printed circuit board with the second printed circuit board being an FR-4 board.

### BRIEF DESCRIPTION OF THE DRAWINGS

The above mentioned and other features of this invention, and the manner of attaining them, will become more apparent and the invention itself will be better understood by reference to the following description of an embodiments of the invention taken in conjunction with the accompanying drawings, wherein:

FIG. 1 is a partial and schematic exploded view of an air-cooled electric machine.

FIG. 2 is a perspective view of a rectifier end assembly for an air-cooled electric machine.

FIG. 3 is a perspective view of the rectifier end assembly with the end cap removed.

FIG. 4 is another perspective view of the rectifier end assembly with the end cap removed.

FIG. 5 is an end view of the rectifier end assembly with the end cap removed.

FIG. 6 is another end view of the rectifier end assembly with the end cap removed.

FIG. 7 is an end view of the rectifier end frame and electronic blocks.

FIG. 8 is a side view of the rectifier end frame and one of the electronic blocks.

FIG. 9 is a cross sectional view of the rectifier end frame and one of the electronic blocks.

FIG. 10 is a partial perspective view of a rectifier end frame and a portion of an electronic block.

FIG. 11 is another partial perspective view of the rectifier end frame and electronic block portion of FIG. 10.

FIG. 12 is an exploded view of an electronic block assembly.

FIG. 13 is a perspective view an electronic block assembly.

FIG. 14 is a perspective view of an alternative thermally conductive plate for the electronic block assembly.

FIG. 15 is a perspective view of fasteners and another thermally conductive plate for the electronic block assembly.

FIG. 16 is a perspective view of an alternative rectifier end frame and one of the power block assemblies.

FIG. 17 is a perspective view of an alternative end cap.

FIG. 18 is a perspective view of the rectifier end frame of FIG. 16 and the end cap of FIG. 17 assembled together.

FIG. 19 is a perspective view of a portion of an accessory.

FIG. 20 is a cross sectional view of housing shell members.

FIG. 21 is side view of two printed circuit boards and a connector.

FIG. 22 is a schematic diagram illustrating a rectifier block and its connection to an electric machine.

FIG. 23 is a schematic diagram of a control board in the rectifier block.

FIG. 24 is a schematic diagram of a power board in the rectifier block.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

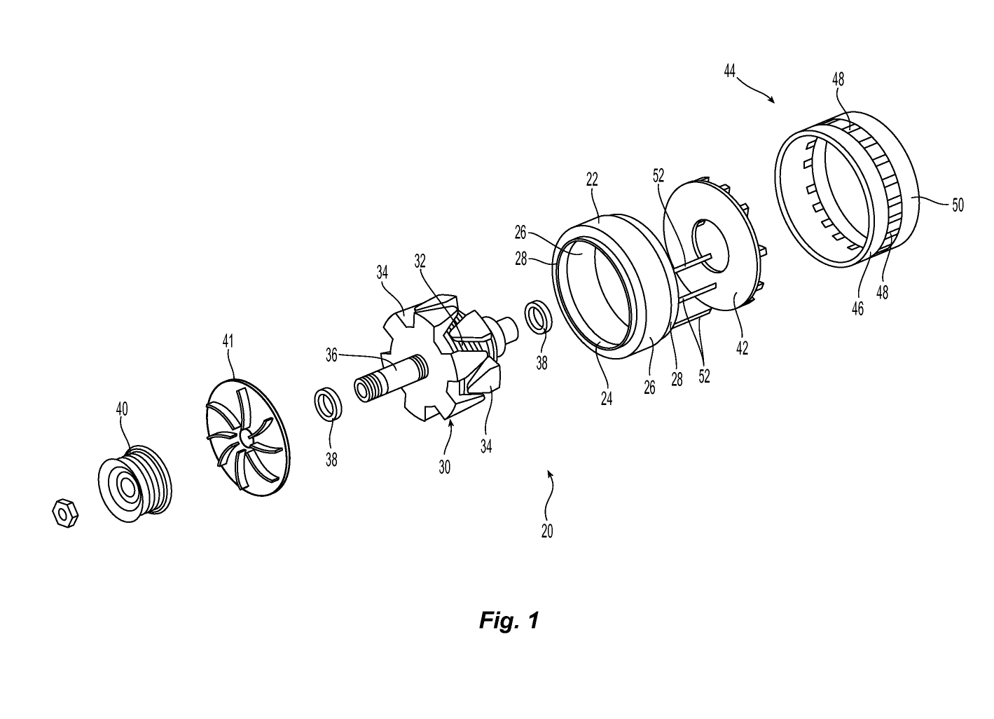

An electric machine 20 is illustrated in FIG. 1 and includes a stator 22 having windings 24 and a stator core 26 with the end turns 28 of the stator windings 24 extending axially beyond the stator core 26. Electric machine 20 also includes a claw-pole rotor 30 with a field coil 32 and magnetic poles 34. The rotor 30 is mounted on a shaft 36. Bearing assemblies 38 rotatably support shaft 36. The illustrated electric machine 20 is an alternator for a vehicle. A pulley 40 is fixed to one end of shaft 36 and a belt (not shown) operably couples pulley 40 with the drive shaft of the vehicle whereby operation of the vehicle engine rotates shaft 36 and rotor 30 mounted thereon to thereby generate an AC electrical current in stator windings 24. A rectifier is used to convert the AC current into DC current. The manner in which a claw-pole alternator generates electrical current is well-known to those having ordinary skill in the art.

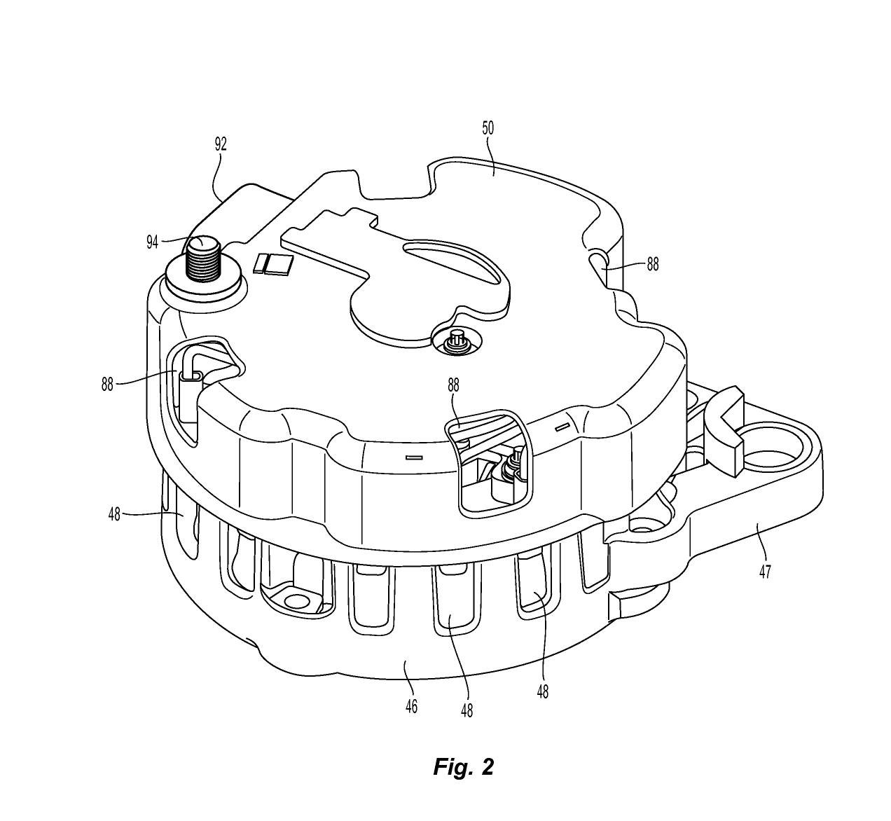

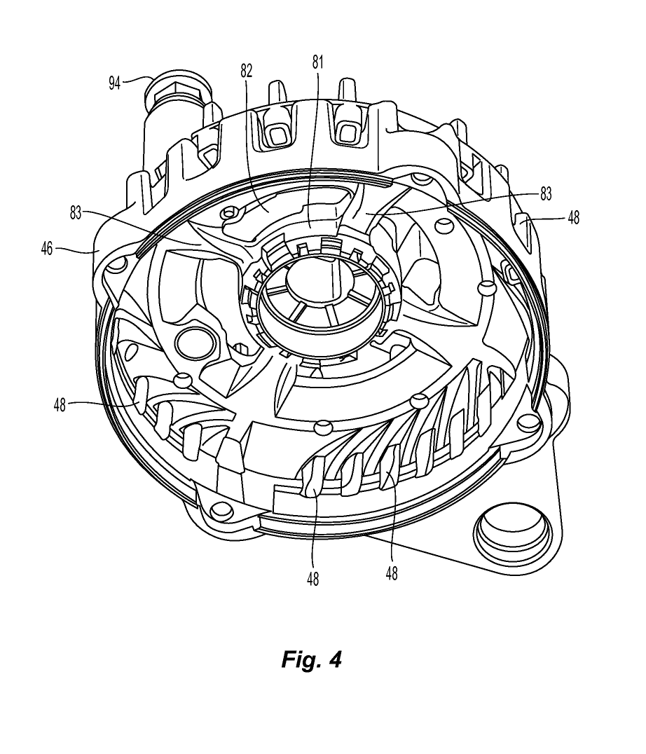

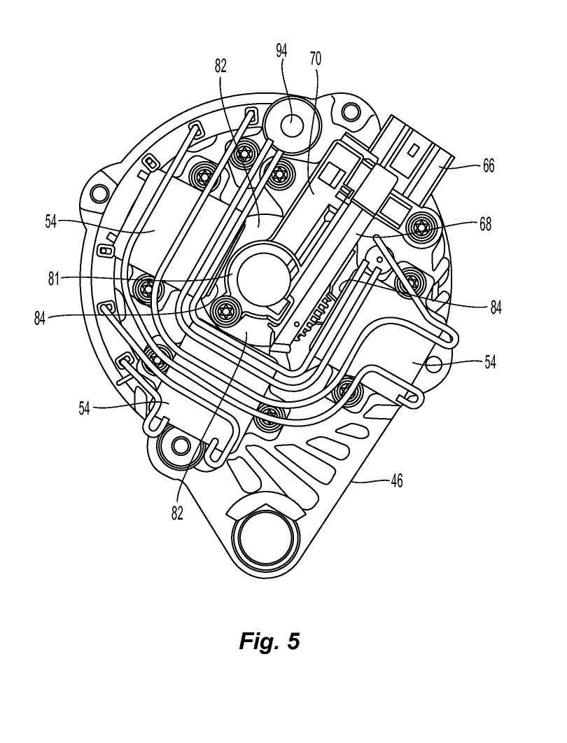

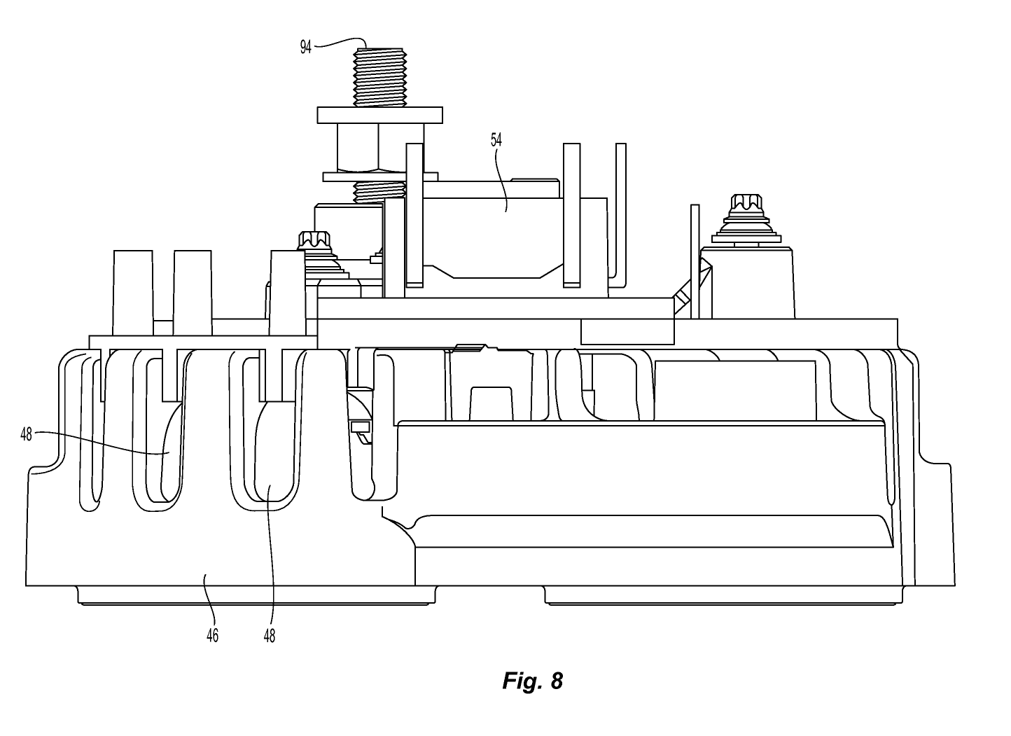

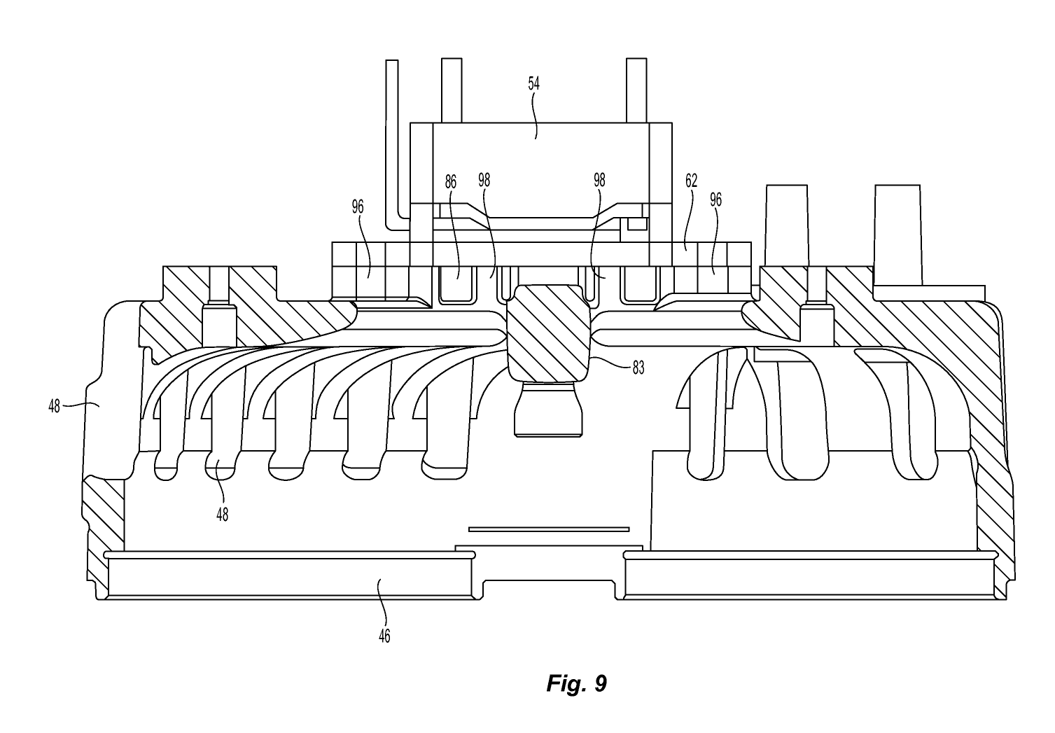

Radial fans 41, 42 are fixed to shaft 36 on opposite axial ends of the rotor 30 and generate an air flow used to cool electric machine 20. In the illustrated embodiment, the rectifier is located on the axial end of electric machine 20 opposite pulley 40 and is located in rectifier end assembly 44 which is further shown in FIGS. 2-9.

The structural members of rectifier end assembly 44 include an end frame member 46 defining a plurality of venting slots 48 and an axial end cap 50. Not shown in FIG. 1 are a central housing member having a generally tubular shape in which stator 22 and rotor 30 are positioned and a second end frame member having a plurality of venting slots which is positioned axially between pulley 40 and radial fan 41. End frame member 46 includes a mounting bracket 47 which is used to mount electric machine 20 on a vehicle.

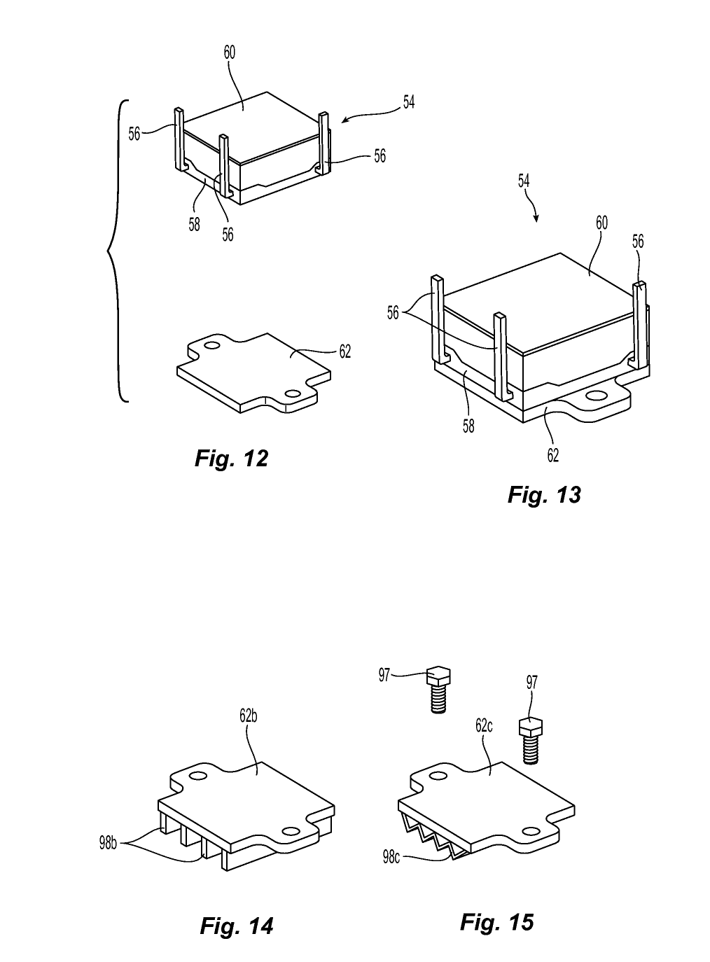

Three phase leads 52 are shown extending from stator windings 24 which are often referred to as coils and communicate the AC current generated in stator windings 24 to rectifier blocks 54. The illustrated embodiments employ MOSFET rectifiers, however, conventional diode rectifiers can alternatively be used with the illustrated embodiments. Electric machine 20 has three rectifier blocks 54. A block 54 can be seen in FIGS. 12 and 13 and forms an accessory having an electrical device, i.e., a MOFSET rectifier, and is associated with electric machine 20. Each of the illustrated power electronic blocks has three leads 56 for electrical connections to electronic circuits 58 within block 54. Circuits 58 include a MOFSET rectifier for converting AC current into DC current in a conventional manner. A housing 60 protects circuits 58 and a thermally conductive base member in the form of a plate 62 is positioned below and thermally coupled with at least a portion of the circuits 58 as discussed in greater detail below.

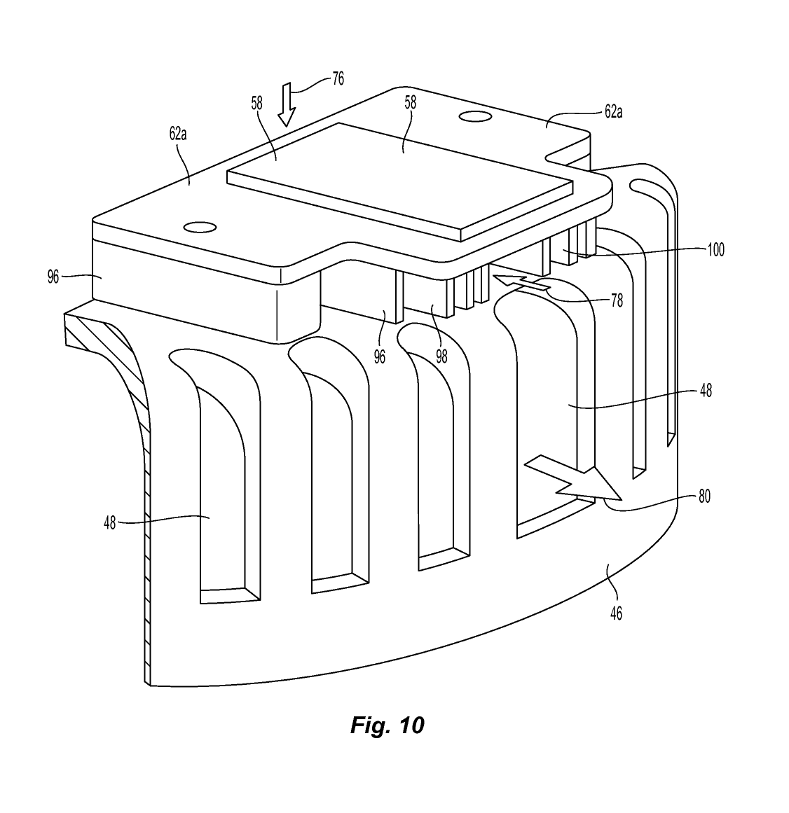

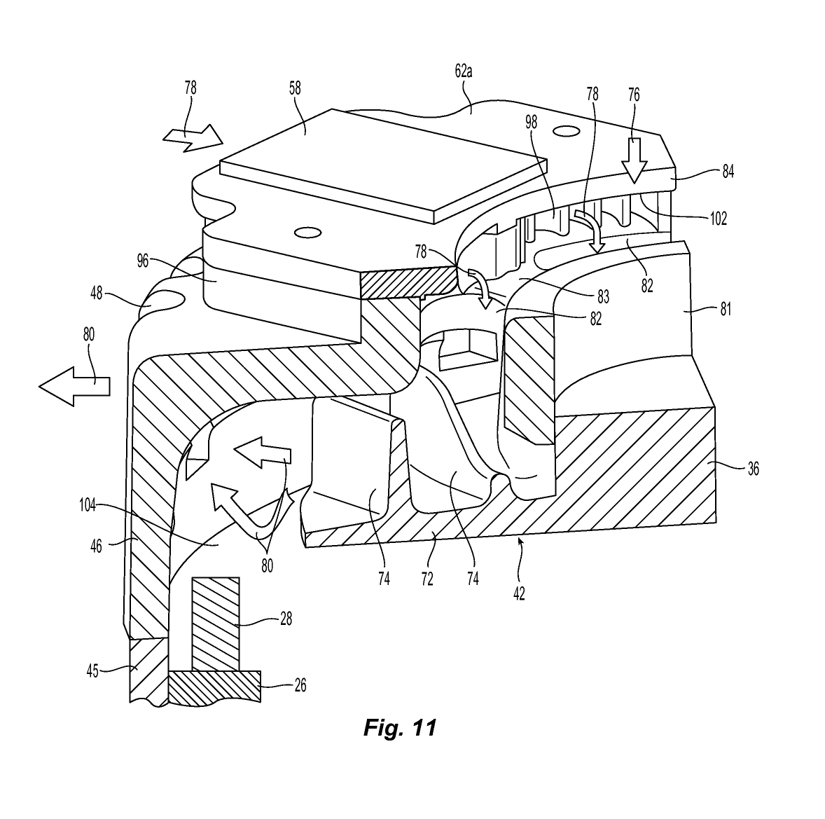

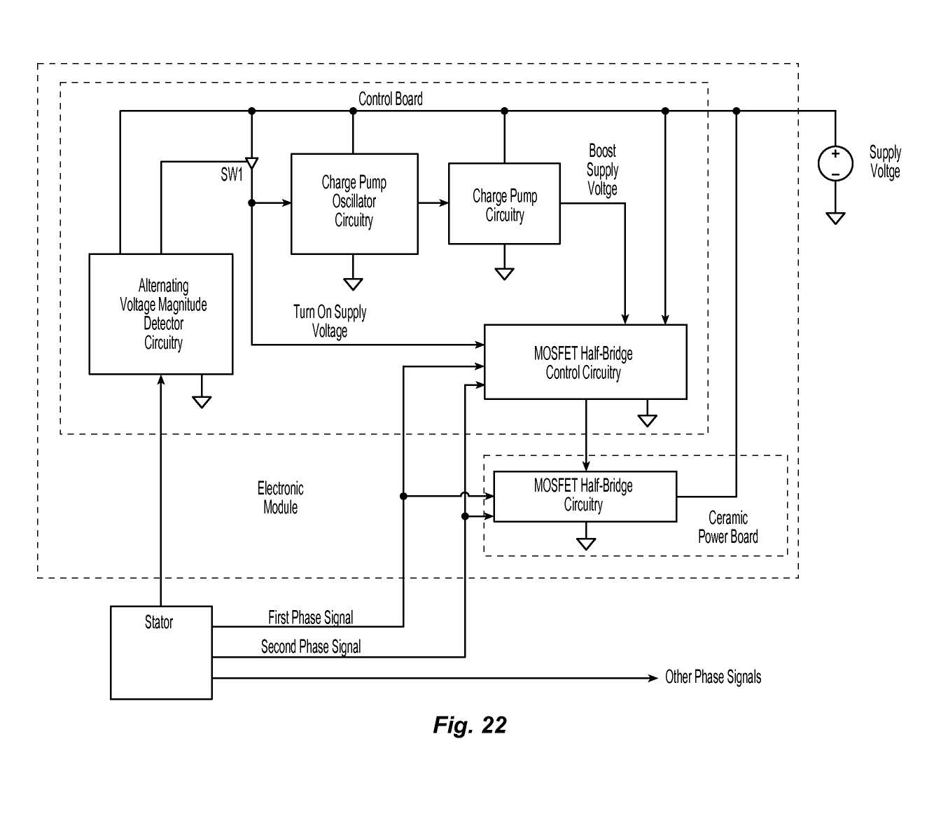

FIGS. 10 and 11 illustrate an embodiment wherein thermally conductive plate 62a has a slightly different shape but functions in the same manner as plate 62. One of the printed circuit boards forming circuits 58 is shown in FIGS. 10 and 11, however, leads 56 and housing 60 are not shown. FIG. 22 schematically depicts circuitry 58 which is disposed on two separate printed circuit boards in the illustrated example. By thermally coupling at least some of the circuitry 58, e.g., one of the two printed circuit boards, which in the illustrated embodiment include MOFSET rectifiers, with plate 62, the thermally conductive plate 62 acts as a heat sink for the thermally coupled circuitry. For example, the printed circuit board (“PCB”) forming the MOFSETs can be formed using surface mount technology with plate 62 being an aluminum plate which forms a heat spreading material base for the PCB. Thermally conductive member 62 is not required to have a generally planar plate-like shape, however, for manufacturing efficiency, a generally planar shape for thermally conductive member 62 will generally be desirable. The structure of blocks 54 and the circuits 58 housed therein is discussed in greater detail below. Plate 62 can function solely as a heat sink or can be used to actively dissipate heat. For example, an air flow can be generated to remove heat from plate 62 whereby plate 62 actively removes heat from at least some of the circuits 58 and transfers excess heat to the external environment.

The DC electrical current produced by the rectifiers is communicated to the vehicle battery, and thus the vehicle electrical system, via B terminal 94 which is the main alternator output terminal. Electrical connector 66 defines additional conventional terminals which provide electrical communication between alternator 20 and the vehicle electrical and control systems. More specifically, connector 66 defines an S terminal connected to the battery for sensing battery voltage; an IG terminal which is connected to the ignition switch and turns the voltage regulator on; and an L terminal which illuminates a warning or charging lamp. In addition to these four terminals, vehicle alternators typically include an F terminal located separately from connector 66 and which is a full-field by-pass for regulator 68. Although the described terminals are used in many applications, alternative embodiments may employ a variety of other configurations. A carbon brush assembly 70 holds two stationary carbon brushes which engage slip rings on shaft 36. Each end of the rotor field winding is connected to one of the slip rings. Regulator 68 monitors the voltage of both the vehicle battery and the stator windings and adjusts the amount of rotor field current to control the output current of the alternator. The terminals, regulator 68 and carbon brush assembly 70 of alternator 20 function in a conventional manner well understood by those having ordinary skill in the art.

Two fans 41, 42 are secured to shaft 36 and rotate along with shaft 36. Fans 41, 42 are radial fans and have a generally disc shaped member 72 and vanes 74 which project in an axial direction from disc 72 and extend radially outwardly. As fans 41, 42 rotate, air is pulled axially inwardly toward disc 72 as vanes 74 force the air radially outwardly. As best understood with reference to FIGS. 10 and 11, arrows 76, 78, 80 depict the flow of air generated by fan 42 at the rectifier end of alternator 20.

As fan 42 rotates, it pulls air into fan 42 along two distinct pathways forming a primary inlet airflow 76 and a secondary inlet airflow 78. Fan 42 is located within end frame member 46 and the two inlet airflows are combined as they enter end frame member 46 through fan ports 82. End frame member 46 includes a central hub 81 through which shaft 36 extends. (FIG. 11 shows only a small portion of hub 81 and shaft 36.) Struts 83 extend between hub 81 and the outer radial portion of end frame member 46 and fan ports 82 are defined between struts 83.

The primary inlet air flow enters fan ports 82 in a generally axially oriented direction and passes radially inwardly of the radially innermost edge 84 of thermally conductive plate 62. Secondary inlet air flow 78 flows in a generally radial direction through an inlet passageway 86 defined between plate 62 and end frame member 46 before changing directions near edge 84 and entering fan ports 82. As secondary inlet flow 78 passes through passageway 86 heat is transferred from plate 62 to air flow 78 thereby cooling electronics 58.

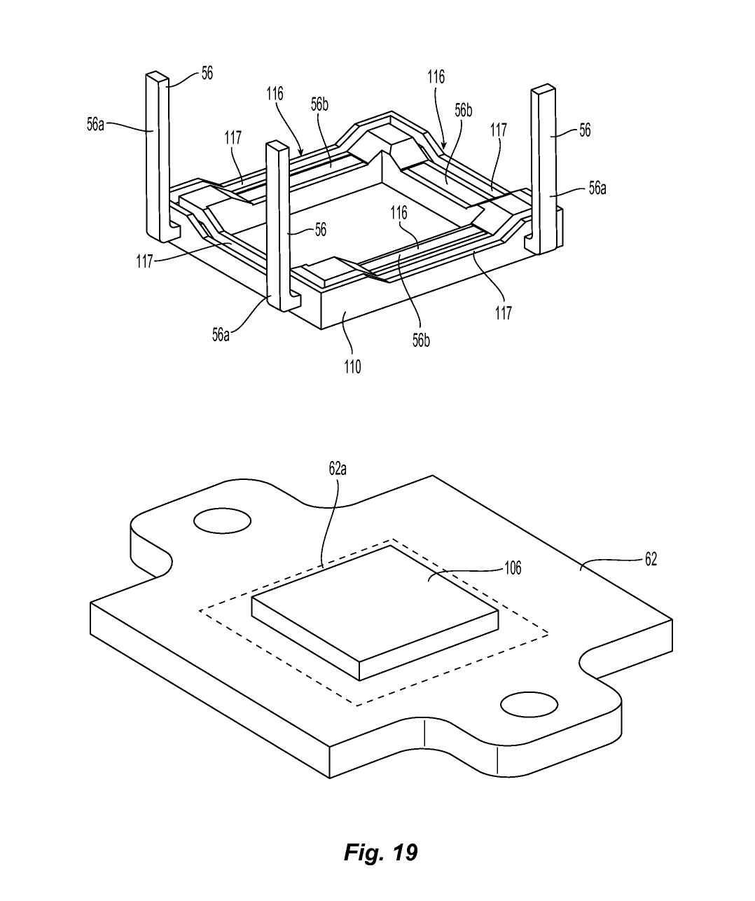

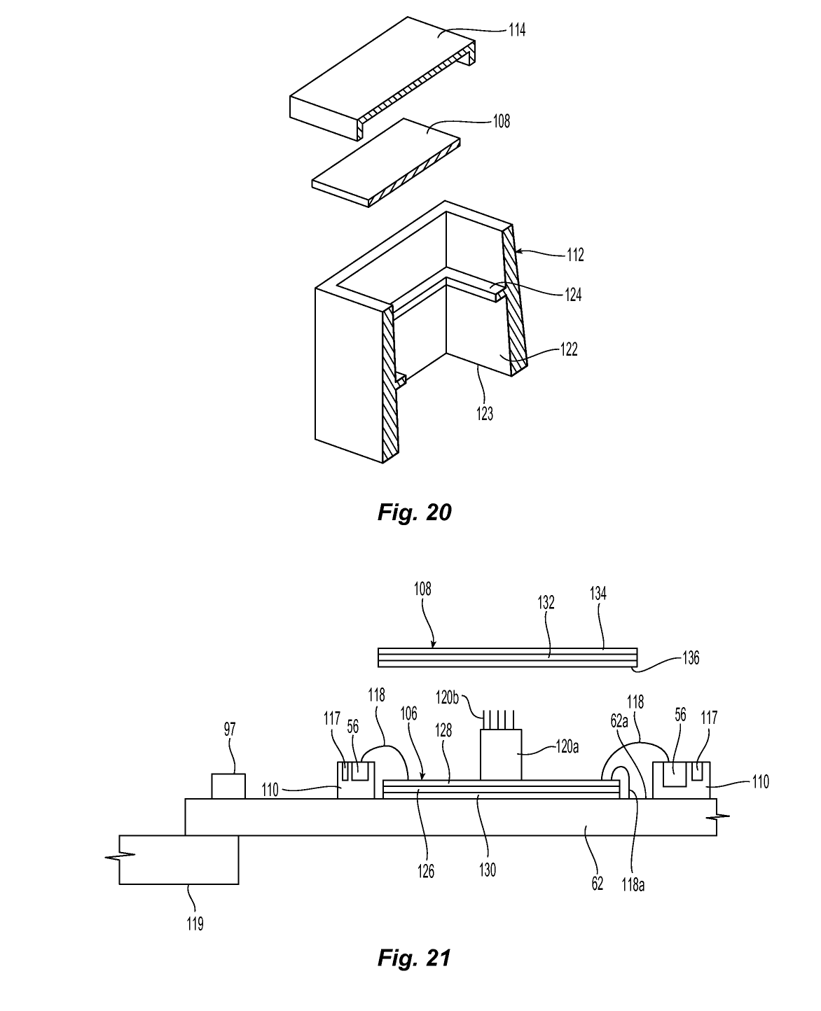

While the structure of the illustrated electric machine 20 provides for the air-cooling of plate 62 and thus the active removal of heat from block 54, alternative embodiments may be configured to have plate 62 function solely as a heat sink to provide for the cooling of block 54. The physical structure of block 54 is best understood with reference to FIGS. 19-21 while FIGS. 22-24 provide an electrical schematic diagram of block 54.

Turning first to FIGS. 19-21, block 54 includes first and second printed circuit boards 106, 108. First PCB 106 defines thermally coupled electronics 58 and is mounted on metallic base member 62 while second PCB 108 is disposed in housing 60 and spaced from base member 62. Housing 60 is defined by polymeric housing shell members 110, 112 and 114.

In the illustrated embodiment, housing member 110 surrounds first PCB 106 and is secured to base member 62 with an adhesive. Housing member 110 is also overmolded about electrically conductive elements 56 which provide electrical communication between PCBs 106, 108 and an external electrical circuit and thereby act as leads for PCBs 106, 108. Conductive elements 56 may take the form of a segment of copper wire or other appropriate material.

Housing member 110 is injection molded over conductive elements 56 with an exterior portion 56a of elements 56 extending out of housing member 110 and another portion 56b being exposed in recessed area 116 of member 110. In the illustrated embodiment, a third portion of conductive element located between inner exposed portion 56b and exterior portion 56a is disposed within housing member 110 and does not have an exposed surface. Housing member 110 defines a slot 117 which extends along the full circumference of member 110 outwardly of exposed areas 56b and which receives second housing member 112.

Exposed portion 56b is used to provide a connection between conductive element 56 and first PCB 106. In the illustrated example, wires 118 have one end wire bonded, i.e., welded, to element 56 in exposed area 56b and an opposite end wire bonded with PCB 106 to thereby allow conductive elements 56 to provide electrical communication between PCB 106 and an external circuit. Although the illustrated embodiment utilizes wire bonding with wires 118, soldering or other appropriate techniques could alternatively be employed with wires 118.

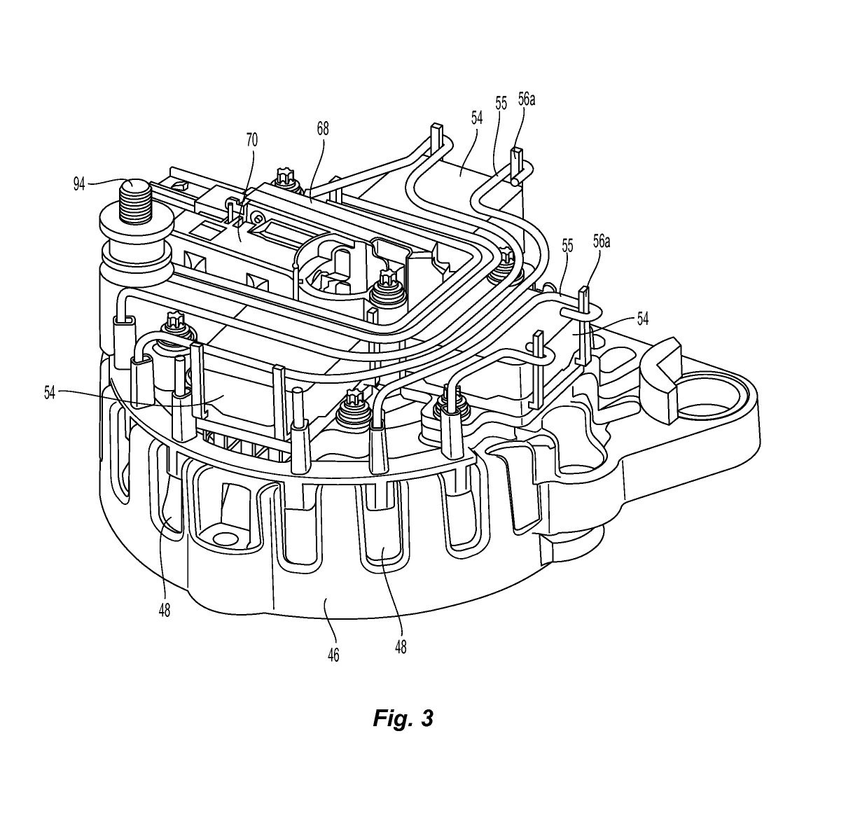

In the illustrated embodiment, three conductive elements 56 are used, each of the conductive elements having an exposed portion 56b and being electrically isolated from each other. Exterior portion 56a is conductively connected with an external circuit 55. In the illustrated embodiments, the external circuits to which conductive elements 56 are connected include stator coils 24 of electric machine 20. The connection of conductive elements 56 to the stator coils is best seen in FIG. 3.

The use of a housing member 110 that is overmolded about conductive elements 56 which act as leads for making electrical connections can be advantageous. For example, the overmolded housing member 110 provides mechanical stability to conductive elements 56. It also facilitates proper positioning of the conductive elements and provides protection from the surrounding environment. The use of exposed portions 56b within the housing to form connections with PCB 106 provides flexibility in the forming of electrical connections between PCB 106 and external electrical circuits.

Conductive elements 56 may be bent into their final shape either before or after the overmolding process. Similarly, conductive elements 56 may be plated either before or after the overmolding process to facilitate the forming of electrical connections. Any suitable method for electrically connecting elements 56 may be employed. For example, crimping, welding or soldering may all be employed to connect elements 56. Generally, a welding process, such as a wire bonding or resistive welding process, will be the most suitable method for forming a connection on the interior exposed portion 56b of elements 56.

The illustrated embodiment utilizes base member 62 to provide a grounding connection for PCBs 106, 108. In alternative embodiments, however, base member 62 may be used solely for its heat sink and dissipation qualities without performing an electrical connection function. When housing member 110 is secured to base member 62, it surrounds first PCB 106 while leaving an exposed portion 62a disposed within housing member 110. A wire 118a, similar to wires 118, can be used to connect exposed surface 62a to a conductive trace on PCB 106. Wire 118a or other suitable method of providing an electrical connection, conductively couples PCB 106, and thus also PCB 108, with an external circuit segment 119 which functions as a ground. In the illustrated embodiment, both direct contact between base member 62 and member 119 as well as fastener 97 conductively couple element 119 with base member 62. External circuit segment 119 can take the form of a frame member that is conductively coupled with other structural members to thereby function as a ground as discussed below.

An externally exposed surface of base member 62 can then to connected to an external circuit. While aluminum will often be an advantageous choice of material for base member 62, when employing base member 62 to provide an electrical connection, copper or other more highly electrically conductive material may be a more advantageous material. Base member 62 could be employed to provide a connection to a stator coil or the vehicle battery, however, if base member 62 is used to provide an electrical connection, it will often be advantageous to use base member 62 to provide a ground connection for PCBs 106, 108. In this regard, it is noted that an aluminum base member 62 is more likely to be sufficient for a grounding connection than other electrical connections and that fasteners 97 can be used to facilitate an electrical connection between base member 62 and an external circuit. For example, if the connection is to ground, base member 62 can be placed in electrical communication with the frame member on which it is secured which may, in turn, be secured via a mounting bracket (and possibly an intermediate alternator frame member on which the bracket is mounted) to the vehicle frame. For example, a rectifier block 54 might include at least three conductive elements 56 wherein two elements 56 are connected with stator coils of two different phases, and one element 56 is connected to the B+ terminal which corresponds to the vehicle battery designated by the supply voltage line in FIG. 22 and with a ground connection being made through base member 62.

A conventional eight pin connector is used to provide electrical communication between first PCB 106 and second PCB 108 in the illustrated embodiment. A connector 120a is mounted on first PCB 106 and has eight conductive pins 120b extending outwardly therefrom which are used to make connections with second PCB 108. Various other methods known in the art, such as wire bonding, may alternatively be employed to provide electrical communication between printed circuit boards 106, 108. As mentioned above, the first PCB 106 and housing member 110 are both secured to mounting member 62. Second housing member 112 has a generally rectilinear tubular shell 122 with two open ends and an inwardly projecting flange 124. The flange 124 does not project all of the way to the center of tubular shell 122 whereby a central passage extends from one end of shell 122 to the opposite end. In the illustrated embodiment, second PCB 108 is secured to flange 124 along its outer perimeter with an adhesive to thereby mount PCB 108 on shell member 122. Flange 124 is positioned so that when the distal edge 123 of shell 122 is positioned in slot 117 the eight pins 120b will project through openings in PCB 108. The eight pins 120b are then soldered to traces on circuit layer 134 of PCB 108. After connecting pins 120b, housing cap 114 is attached to housing member 112. Although the illustrated embodiment utilizes an eight pin connector, alternative embodiments could utilize metallized tabs projecting from PCB 106 or other suitable methods to provide electrical communication between PCBs 106 and 108.

Second polymeric housing member 112 is also secured to housing member 110 during the installation of housing member 112 and PCB 108. This securement could be by a friction fit engagement or adhesive securement at slot 117 or other point of contact, by fastener or other appropriate method. As mentioned above, third polymeric housing member 114, in the form of a cap, is secured to housing member 112 opposite base member 62. Cap 114 can be secured to housing member 112 by a press-fit engagement, adhesive, fastener or other appropriate method. In the illustrated embodiment, polymeric housing members 110, 112 and 114 are formed by an injection molding process out of a polymeric material suitable for the anticipated environment of the application.

A thermally conductive and electrically non-conductive silicon gel is advantageously used to substantially fill the space within the housing between PCB 106 and PCB 108. The silicon gel provides mechanical stability for the electrical connections and also performs a heat transfer function. An epoxy resin can also be used to substantially fill this space and provide mechanical support.

Alternative embodiments could employ a single PCB instead of the two PCBs 106, 108 used in the illustrated embodiment. The use of a single PCB would allow all of the circuits defined by the PCBs to be mounted on base member 62. The use of two different PCBs, however, provides several advantages. Those components which generate the most heat, e.g., the MOSFET rectifier, can be located on first PCB 106 thermally coupled with base member 62 while those circuit components which do not require active heat removal for proper functioning can be positioned on second PCB 108 which is supported by housing shell member 112.

The use of two separate PCBs provides flexibility in the shape of the final package of block 54 and allows base member 62 to be sized based upon cooling requirements instead of sized to fit the dimensions of a single larger PCB that includes the circuits of both PCBs 106, 108.

The use of two separate PCBs also allows PCBs 106, 108 to be manufactured out of different materials. This allows first PCB 106 to be manufactured using a substrate with a relatively high thermal conductivity to promote the transfer of heat to base member 62 while second PCB 108 can be manufactured using a substrate that has a lower thermal conductivity but which is also less expensive. For example, PCB 106 may advantageously employ a ceramic substrate while PCB 108 employs a fiberglass and epoxy substrate such as an FR-4 substrate.

The structures of PCBs 106, 108 are best understood with reference to FIG. 21. As schematically depicted in FIG. 21, PCB 106 has a ceramic substrate 126 with an etched copper layer 128 defining the printed circuits. Components, e.g., a MOSFET rectifier, can be disposed on layer 128. Although not essential, a silver or copper layer 130 can be formed on the opposite side of substrate 126 which does not have circuits etched therein and is electrically insulated from circuit layer 128. Metal layer 130 is soldered to metal base member 62 and thereby thermally couples and secures PCB 106 to base member 62 and promotes the transfer of heat but does not have any circuitry function.

PCB 108 includes a substrate layer 132 and two copper layers 134 and 136 which both define etched circuits. Electrical communication may be provided between the two layers 134, 136 by vias or other suitable methods known in the art. In the illustrated embodiment, the pins of connector 120b extend through PCB 108 and are connected to traces on layer 134 by soldering.

As mentioned above, PCBs 106 and 108 may advantageously be manufactured using different substrates. Using a robust and heat conductive ceramic substrate for those components that require or would benefit from the use of such a substrate and using a less expensive FR-4 substrate for circuit components which do not generate significant heat and for which an FR-4 substrate is sufficiently robust.

The use of a ceramic substrate 126 with PCB 106 facilitates the transfer of heat generated by the operation of components on PCB 106 to metal base layer 62. Substrate layer 126 may be formed out of alumina (Al₂O₃) or other suitable materials such as beryllium oxide (BeO), aluminum nitride (AlN) or other materials known in the art for forming ceramic substrates. PCBs having such ceramic substrates are commercially available. A ceramic substrate 126 having 96% or more, e.g., 98% or 99%, alumina are available and typically provide a thermal conductivity of approximately 24 to 28 W/m/° K. This compares to a thermal conductivity of approximately 0.27 W/m/° K for FR-4 substrates. Beryllium oxide and aluminum nitride substrates provide even greater thermal conductivity values. For example, aluminum nitride substrates may have a thermal conductivity in excess of 150 W/m/° K. Alumina substrates, however, are typically less expensive than other ceramic substrates and provide a substantial improvement over the thermal conductivity of FR-4 substrates. The illustrated embodiment may be manufactured using a 96% alumina substrate 126 having a thickness of approximately 0.025 inches (0.64 mm) to 0.035 inches (0.89 mm).

Another advantage of ceramic substrates is that such substrates generally have a low coefficient of thermal expansion (“CTE”). For example, aluminum nitride has a CTE of approximately 4.5 ppm/° C. which is very similar to silicon which has a CTE of approximately 4.0 ppm/° C. while a FR-4 substrate may have a CTE of 6.6 to 13 or 14 ppm/° C. in the x and y directions and a CTE of 175 ppm/° C. in the z-direction. Conventional MOSFET rectifiers, such as that disposed on PCB 106, include a silicon layer and by utilizing a substrate having a CTE which is similar to silicon, the stresses induced by differential thermal expansion can be minimized. Thus, the low coefficient of thermal expansion of a ceramic substrate which more closely matches that of silicon enhances thermal cycling performance and provides for a more robust and reliable product.

The use of an FR-4 PCB to form second PCB 108 allows PCB 108 to be efficiently manufactured using relatively inexpensive and widely available materials and processes. FR-4 is a designation used with a standardized composite material formed out of a woven fiberglass cloth and an epoxy resin binder. FR-4 materials can be used to form a flame resistant laminate sheet suitable for manufacture of PCBs and FR-4 is widely used as an electrically insulative substrate when manufacturing PCBs. FR-4 materials may also be used for other purposes. In the illustrated example shown in FIG. 21, substrate layer 132 of PCB 108 is an FR-4 substrate. A thin layer of copper foil 134, 136 is laminated on each side of substrate 132 and has circuits etched therein to produce the desired printed circuits. In the illustrated example, a circuit layer 134, 136, is located on each side of substrate 132, however, alternative embodiments might include a single layer on only one side of substrate 132 or PCB 108 might employ multilayer circuitry with additional substrate and circuit layers. The manufacture of PCB employing FR-4 substrates is well-known to those having ordinary skill in the art.

Another advantage to the use of two separate PCBs is that it facilitates the repair, replacement and/or upgrading of one of the PCBs while leaving the other PCB unchanged. The modular nature of the accessory 54 also facilitates efficient manufacturing.

If a rectifier block 54 needs repair, instead of replacing the entire unit, it may be possible to replace only PCB 106, and those elements permanently secured thereto, e.g., base member 62 and housing member 110, or PCB 108, and those elements permanently secured thereto, e.g., housing member 112. Similarly, in a remanufacturing operation, it may only be necessary to replace PCB 108 and any housing members, e.g., housing 112, permanently attached thereto instead of replacing the entire rectifier block 54 and both of the PCBs 106, 108 contained therein. The illustrated circuits provide one example of a suitable circuit arrangement, however, alternative embodiments may employ other circuit arrangements.

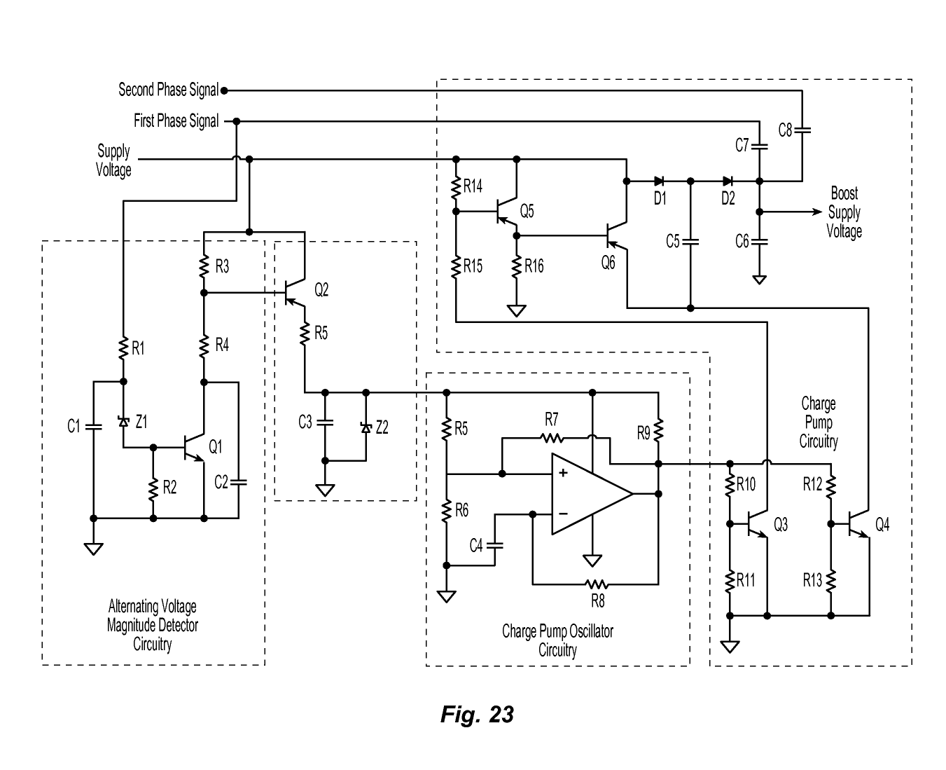

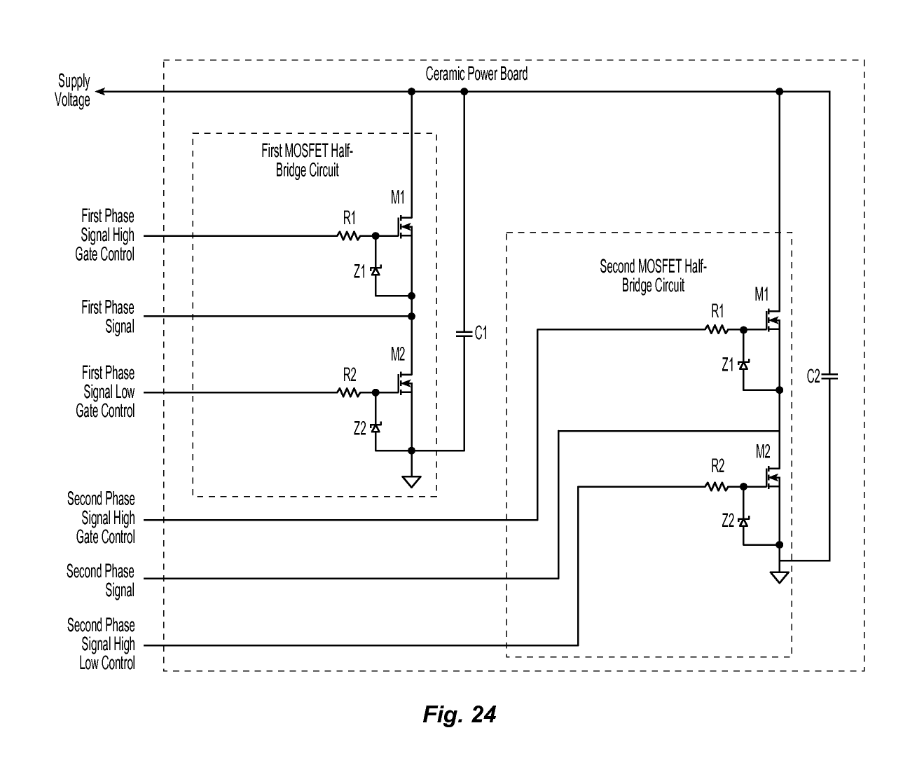

FIGS. 22-24 provide a schematic diagram of the circuitry of PCBs 106, 108. FIG. 22 shows the overall layout of first PCB 106 which is labeled “CERAMIC POWER BOARD” and second PCB 108 which is labeled “CONTROL BOARD” in FIG. 22. FIG. 23 provides a more detailed schematic diagram of the control board, i.e., PCB 108 in the illustrated embodiment. As shown in FIGS. 22 and 23, the control board includes alternating voltage detector circuitry, charge pump oscillator circuitry, charge pump circuitry, and MOSFET half-bridge control circuitry, all of which is generically referred to as control circuitry herein. FIG. 24 provides a detailed schematic diagram of the MOSFET rectifier circuitry disposed on PCB 106. A person having ordinary skill in the art will appreciate that the disclosed circuitry provides for the conventional control and operation of a MOSFET rectifier.

It is also noted that the illustrated embodiment utilizes a PCB 106 having two MOSFET ½ bridges (each ½ bridge replaces two diodes of a conventional rectifier). Alternative configurations, however, could also be employed. For example, each rectifier block 54 could include only one ½ bridge or could include more than two ½ bridges.

It is further noted that while the disclosed embodiment positions the alternating voltage detector circuitry, charge pump oscillator circuitry, charge pump circuitry, and MOSFET half-bridge control circuitry on the second PCB 108, alternative embodiments could position some, or all, of this circuitry on the first PCB 106. As discussed elsewhere in this application, however, a number of advantages are obtainable by placing some or all of the control circuitry on a second PCB 108.

One further advantage of placing the control circuitry on the second PCB 108 is that it quickens and lessens the expense of design changes. Changes in the design of a printed circuit board can be quite expensive after manufacture of a product has begun or preparations for manufacture have taken place. If the necessary design changes are located on only one of the PCBs 106, 108, the expense of the design change can be reduced.

Such design changes may be necessary as the product design is finalized during the initial introduction of the product. More commonly, such design changes are necessary one or more years after the introduction of a product to upgrade or improve the product or to respond to changes in the marketplace. Changes may also be required because the electric machine or vehicle for which the product is intended have undergone design changes necessitating changes in PCB 106 or 108. If the change is only to the control circuitry, it may be possible to continue manufacturing first PCB 106 without change while altering only the design of the circuitry found on second PCB 108.

It may also be possible to employ differently configured second PCBs 108 with a single configuration of first PCB 106. For example, electric machines having different applications might employ the same rectifier configuration of PCB 106 but require different control circuitry found on PCB 108. By attaching the appropriate PCB 108, the same PCB 106 and same housing members could be used with two different products. For example, a PCB 106 may be capable of performing as either a rectifier for converting AC current into DC current or as an inverter for converting DC current into AC current with one PCB 108 being optimized to function with the PCB 106 operating as a dedicated rectifier and a differently configured PCB 108 being optimized to function with the PCB 106 operating as a dedicated inverter. Yet another PCB 108 might be configured to selectively operate the electric machine as a rectifier or inverter.

As mentioned, an electric machine accessory 54 in accordance with the present application can be employed with a variety of electric machines and is not limited to use with the alternator illustrated in the attached figures. Moreover, accessory 54 can be used with electric machines having different cooling systems or no active cooling systems in addition to the illustrated air cooled electric machine 20. As discussed above, the illustrated electric machine 20 generates an air flow that can be used to actively cool base member 62. This air flow is generated by a radial fan 42. While this air cooling of the illustrated rectifier block 54 is optional, it can be quite beneficial and is further discussed below.

Although not shown in FIGS. 10 and 11, axial end cap 50 also defines the path of the inlet airflows 76, 78. Cap 50 can be seen in FIG. 2 and includes three side inlet openings 88 through which air may enter inlet passageway 86 air entering side inlets 88 may also circulate within cap 50 and flow along primary inlet flow 76. FIGS. 17 and 18 show an end cap 50 with additional openings 90 on the axial end surface of cap 50 to enhance the flow of air along primary inlet flow path 76. With reference to FIGS. 17 and 18, it is further noted that shrouded opening 92 permits access to electrical connector 66 (not shown in FIGS. 17 and 18) and B terminal 94 (not shown in FIGS. 17 and 18) extends through terminal opening 94.

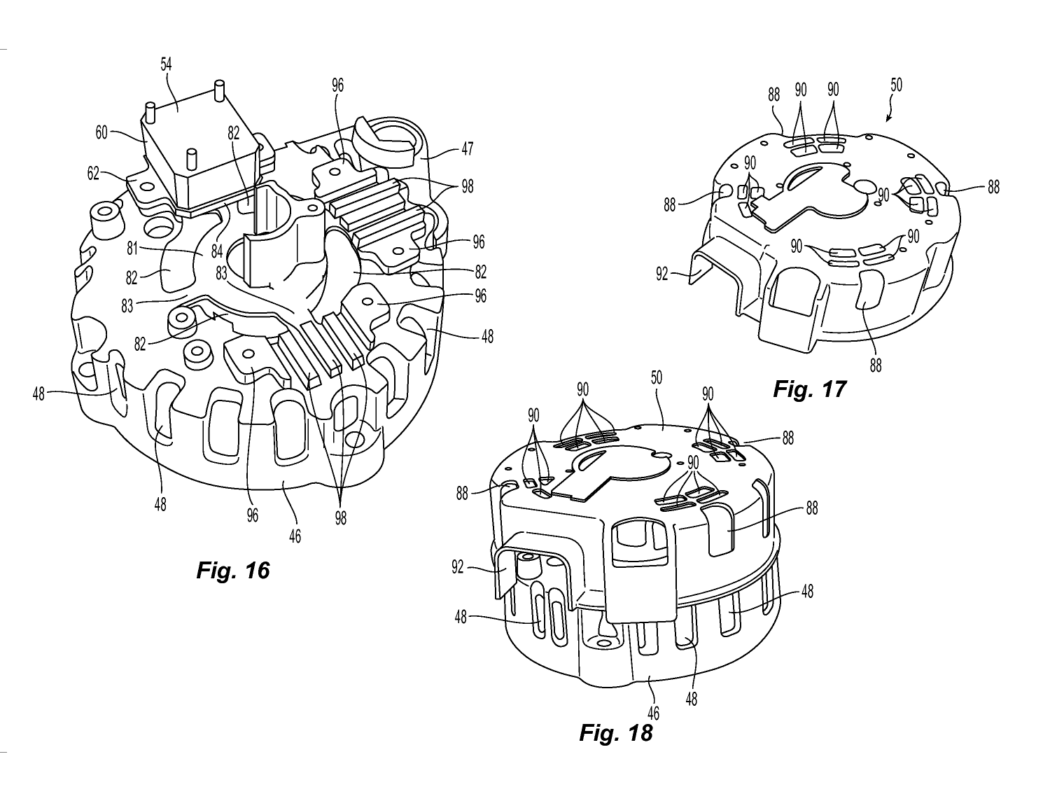

Secondary passageway 86 is best understood with reference to FIGS. 3, 7, 9-11 and 16. In the illustrated embodiment, there are three rectifier blocks 54 and a separate passageway 86 is defined between each of the blocks 54 and end frame member 46. In FIG. 16, only one of the rectifier blocks 54 is illustrated. As can be seen in FIG. 16, end frame 46 includes stand-offs 96 and ribs 98 which axially project from end frame 46 and have distal ends which engage plate 62 of blocks 54. End frame member 46 is formed out of a thermally conductive material such as metal and, in the illustrated embodiment, is a cast aluminum material. The engagement between plate 62 and stand-offs 96 and ribs 98 thermally couples plate 62 with stand-offs 96 and ribs 98. The thermal coupling of plate 62 with stand-offs 96 and ribs 98 allows heat to be transferred from plate 62 to stand-offs 96 and ribs 98 thereby increasing the capacity of the heat sink coupled with electronics 58. Plate 62, stand-offs 96 and ribs 98 also all define a portion of the exposed surface of air flow passageway 86 thus providing a heat transfer surface or heat exchange surface for the dissipation of heat from these surfaces.

In the illustrated embodiments, plates 62 are attached to stand-offs 96 with threaded fasteners 97. Stand-offs 96 form the outer lateral boundary of passageway 86 while ribs 98 run parallel with the air flow within passageway 86. When fan 42 is operating, relatively cool air from the external environment enters cap 50 through side openings 88 and enters passageway 86 through an opening 100 at the radially outermost edge of plate 62. The cool air then flows through passageway 86 toward edge 84 where it is combined with the primary inlet airflow 76 and enters fan ports 82.

The primary inlet airflow 76 enters cap 50 through an end opening 90 or through a side inlet opening 88. Side inlet openings are larger than openings 100 to passageway 86 and permit the flow of air through cap 50 to primary inlet airflow 76. Some air entering side inlets 88 and subsequently entering primary inlet airflow 76 may flow around and/or over blocks 54. In the illustrated embodiment, such airflow has limited cooling impact on blocks 54. Housing 60 is formed out of a polymeric or plastic material and does not allow for the efficient transfer of heat. Some heat, however, may be transferred by the exposed upper surface of plates 62 proximate fasteners 97.

Thus, the air in primary inlet airflow 76 will have a temperature which is substantially the same as the air in ambient environment surrounding alternator 20. The temperature of secondary air flow 78 will be at the ambient air temperature when it enters opening 100 of passageway 86 but will be slightly warmer as it enters fan port 82 because of the heat it picks up from plate 62, stand-offs 96 and ribs 98 as it travels through passageway 86. The quantity of heat generated by electronics 58, however, is only a small fraction of the heat generated within stator 22 and the temperature increase experienced by secondary inlet airflow 78 in passageway 86 is relatively small. In other words, when secondary inlet airflow 78 enters fan port 82 will still have the capacity to absorb heat generated by stator 22 under the range of operating conditions which can reasonably be expected for a vehicle alternator to experience.

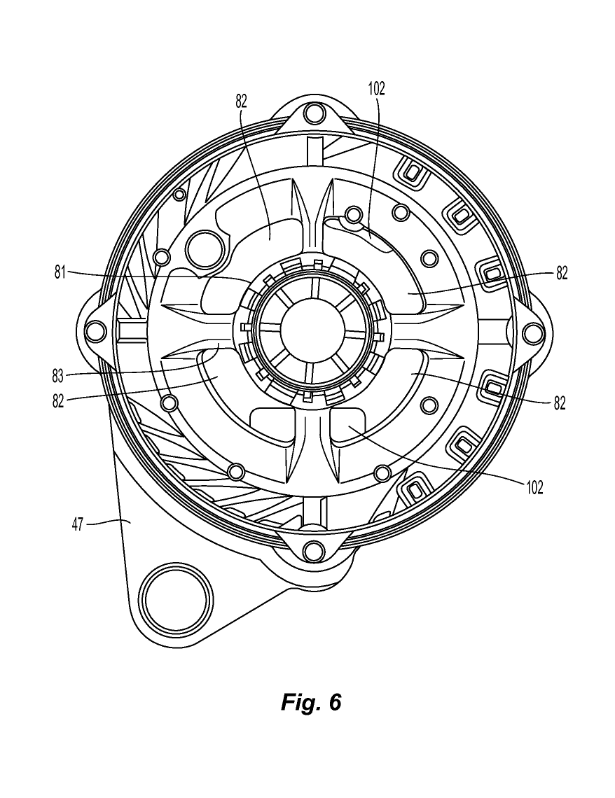

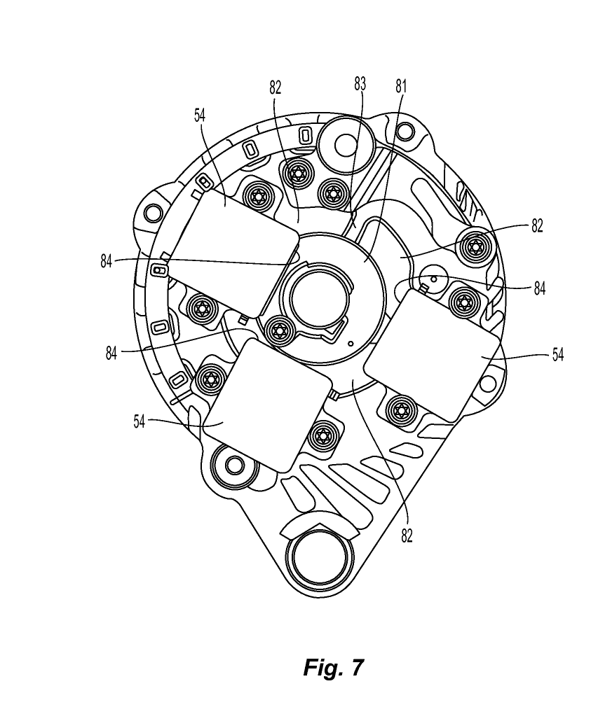

The radially innermost edge 84 of plate 62 forms an overhanging lip 102 with respect to fan ports 82 and acts as a baffle whereby fan 42 not only induces primary air stream 76 to enter fan ports 82 but also induces secondary inlet airflow 78 to enter fan ports 82. Overhanging lip or baffle 102 is best seen in FIGS. 6, 7 and 11. FIGS. 6 and 7 are axial end views which clearly show how plate 62 overhangs fan ports 82 to form a baffle 102. (FIG. 7 illustrates all three of the rectifier blocks 54, however, not all of the rectifier blocks are visible in FIG. 6.) Baffle portion 102 of plates 62 inhibit the entry of primary inlet airflow 76 through a portion of fan ports 82 adjacent passageways 86 to thereby induce air from passageway 86 into fan ports 82. In other words, the relatively low air pressure zone created by fan adjacent to fan ports 82 is in communication with passageway 86 instead of air stream 76 due to overhanging lip 102.

As mentioned above, ribs 98 engage and are thereby thermally coupled with plate 62 and act as heat dissipating fins as air flows through passage 86. Instead of employing ribs 98 which project from end frame 46 to engage plate 62, alternative configurations may also be employed to increase the surface area of passageway 86 that is thermally coupled with plate 62. For example, the ribs could be integral with plate 62 instead of end frame member 46 as depicted in FIG. 14 which illustrate a thermally conductive plate 62b having ribs 98b projecting therefrom. Yet another alternative configuration is shown in FIG. 15 which illustrates a thermally conductive plate 62c having a thin folded sheet metal structure 98c attached to its underside. When using plates 62b, 62c, end frame member 46 will not include ribs 98 but will still include stand-offs 96 for attaching plates 62b, 62c. Various other configurations of passageway 86 may also be employed, for example, stand-offs could be provided on the thermally conductive plate instead of end frame member 46 or the passageway 86 could be arranged to extend in an alternative direction.

As also discussed above, diverting a portion of the incoming air through secondary passageway 86 provides for the cooling of an accessory such as rectifier electronics 58. Although the illustrated embodiments illustrate rectifier block 54 being cooled by air flow through passageway 86, other elements of alternator 20, such as regulator 68 or a control module, could alternatively or additionally be cooled by means of such secondary inlet air flows.

As inlet airflows 76, 78 enter fan ports 82 they intermingle and are combined as they are discharged by fan 42 in a radially outward direction as indicated by arrows 80. Air is discharged from fan 42 into a generally toroidal space 104 where the air contacts surfaces thermally coupled with stator 22 and thereby removes heat from stator 22 before being discharged into the ambient environment through venting slots 48. In other words, the exposed surfaces of space 104 thermally coupled with stator 22 form a heat transfer surface for dissipating heat generated by the operation of electric machine 20. In the illustrated embodiment, air flow 80 can directly contact end turns 28 before exiting through venting slots 48. In some electric machine configurations, air flow 80 may also be able to directly contact the axial end of stator core 26. As schematically depicted in FIG. 11, central housing member 45 is a metal housing member and is in direct contact with the outer surface of stator core 26 and thus thermally coupled with stator core 26. Housing member 45 is also in direct contact and thermally coupled with end frame member 46. Air flow 80 directly contacts end frame member 46 within toroidal space 104 and, thus, removes heat indirectly from stator core 22 as it flows through space 104 and exits venting slots 48. As illustrated, air flow 80 would also directly contact housing member 45 for removal of heat therefrom. Various other configurations can alternatively be used to channel the discharge air flow 80 to promote the transfer of heat from electric machine 20 to air flow 80.

At the pulley end of alternator 20, inlet openings are formed in the axial end of the alternator housing through which air is induced to enter the housing by fan 41. Fan 41 then expels the air radially outwardly into a toroidal space and out through vents similar to space 104 and vents 48 to thereby air cool the opposite end of stator 22 and the end turns 28 projecting therefrom. The pulley end of alternator 20 includes only a primary inlet air flow and discharge flow and does not include a secondary inlet airflow for cooling an accessory. Alternative embodiments, however, could employ secondary air inlet flows for cooling accessories on both axial ends of the electric machine.

While an electric machine in the form of an alternator has been disclosed herein to provide an example of the present invention, the present invention may also be employed with wide variety of other electric machines including various other generator applications, motor applications and motor/generator applications. Moreover, while the illustrated mounting member 62 used with accessory 54 is air-cooled, other cooling methods may be employed. Or, no active cooling of mounting member 62 may be employed whereby member 62 functions solely as a heat sink.

While this invention has been described as having exemplary designs, the present invention may be further modified within the spirit and scope of this disclosure. This application is therefore intended to cover any variations, uses, or adaptations of the invention using its general principles.

What is claimed is:

1. An electric machine comprising:
a stator and a rotor operably coupled therewith;
an accessory operably coupled with the electric machine, the accessory having a housing and an electrical device mounted within the housing; and
at least one conductive element extending through the housing; the conductive element having an exposed portion disposed within the housing and an exterior portion extending outwardly from the housing; the exposed portion being conductively coupled with the electrical device and the exterior portion being conductively coupleable to an external circuit whereby the conductive element provides electrical communication between the electrical device and the external circuit.

2. The electric machine of claim 1 wherein the electric machine comprises the external circuit.

3. The electric machine of claim 2 wherein the external circuit comprises a stator coil.

4. The electric machine of claim 1 wherein the electrical device comprises a rectifier.

5. The electric machine of claim 4 wherein the rectifier is a MOSFET rectifier.

6. The electric machine of claim 1 wherein the electrical device comprises a first printed circuit board and a second printed circuit board, the first and second printed circuit boards having different substrates.

7. The electric machine of claim 6 wherein the first printed circuit board includes a MOSFET rectifier and the second printed circuit board includes control circuitry.

8. The electric machine of claim 7 wherein the housing includes a metallic base member and the first printed circuit board is mounted on and is in thermal communication with the base member, the housing further comprising a polymeric shell member disposed on the base member, the second printed circuit board being mounted on the polymeric shell member and spaced from the base member.

9. The electric machine of claim 8 wherein the base member provides electrical communication between the first printed circuit board and an external circuit segment.

10. The electric machine of claim 8 wherein the first printed circuit board is a ceramic printed circuit board and the second printed circuit board is an FR-4 board.

11. An electric machine comprising:
a stator and a rotor operably coupled therewith;
an accessory operably coupled with the electric machine, the accessory having a housing with a metallic base member and a polymeric shell member; the accessory further including a first printed circuit board mounted within the housing and thermally coupled with the base member; and
at least one conductive element extending through the polymeric shell member, the conductive element having an exposed portion disposed within the polymeric shell member and an exterior portion extending outwardly from the polymeric shell member; the exposed portion being conductively coupled with the first printed circuit board and the exterior portion being conductively coupleable to an external circuit whereby the conductive element provides electrical communication between the first printed circuit board and the external circuit.

12. The electric machine of claim 11 wherein the external circuit comprises a stator coil.

13. The electric machine of claim 11 wherein the first printed circuit board includes a MOSFET rectifier.

14. The electric machine of claim 11 wherein the accessory further comprises a second printed circuit board wherein the second printed circuit board includes control circuitry and is mounted on the polymeric shell member and spaced from the base member and wherein the first printed circuit board has a first substrate and the second printed circuit board has a second substrate, the first substrate having a greater thermal conductivity than the second substrate.

15. The electric machine of claim 14 wherein the first printed circuit board is a ceramic printed circuit board and the second printed circuit board is an FR-4 board.

16. The electric machine of claim 11 wherein the base member provides electrical communication between the first printed circuit board and an external circuit segment.

17. An electric machine and accessory assembly, the assembly comprising:
a stator and a rotor operably coupled therewith;
an accessory operably coupled with the electric machine, the accessory having a housing with a metallic base member; the accessory further including first and second printed circuit boards disposed within the housing, the first printed circuit board being thermally coupled with the base member and the second printed circuit board being spaced from the base member, the first printed circuit board having a first substrate, the second printed circuit board having a second substrate, the first substrate having a greater thermal conductivity than the second substrate.

18. The electric machine and accessory assembly of claim 17 wherein the housing further comprises a polymeric shell member, the second printed circuit board being mounted on the polymeric shell member.

19. The electric machine and accessory assembly of claim 17 wherein the first printed circuit board is a ceramic printed circuit board comprising a MOSFET rectifier and the second printed circuit board is an FR-4 board comprising control circuitry.

20. The electric machine and accessory assembly of claim 17 wherein the base member provides electrical communication between the first printed circuit board and an external circuit segment.
